(19) United States
(12) Patent Application Publication
(10) Pub. No.: US 2024/0364041 A1
(43) Pub. Date: Oct. 31, 2024

(54) ELECTRICAL CONNECTOR

(71) Applicant: HIROSE ELECTRIC CO., LTD., Yokohama-shi, Kanagawa (JP)

(72) Inventors: Takuya Morishita, Yokohama-shi (JP); Namiki Toyosu, Yokohama-shi (JP)

(21) Appl. No.: 18/640,818

(22) Filed: Apr. 19, 2024

(30) Foreign Application Priority Data
Apr. 27, 2023 (JP) 2023-073574

(51) Int. Cl. H01R 13/405; H01R 13/03; H01R 13/213; H01R 13/514

(52) U.S. Cl. CPC H01R 13/405; H01R 13/03; H01R 13/213; H01R 13/514

(57) ABSTRACT

An electrical connector includes a housing and a fitting, a terminal of the fitting includes: a first wall which is provided so as to extend in a Z direction orthogonal to a mounting surface of a mounting portion of the terminal and which forms a first wall surface including a single contact point configured to come into contact with a counterpart terminal; and a second wall which is provided at an end on one side of the first wall in the Z direction and which forms an exposed surface being spaced apart from the mounting surface and not coming into contact with the housing, the terminal being configured to come into contact with the counterpart terminal by the single contact point, and a first thickness of a plated portion on the first wall surface is greater than a second thickness of a plated portion on the exposed surface.

### BACKGROUND OF THE INVENTION

### Field of the Invention

The present invention relates to an electrical connector and, particularly, to an electrical connector to be mounted to an electrically-connected mounted object such as a circuit board and an electric cable.

### Description of the Related Art

Conventionally, as an electrical connector to be mounted to an electrically-connected mounted object such as a circuit board and an electric cable, for example, an electrical connector is known which is manufactured by having a plurality of terminal portions integrally provided with a carrier being integrally molded with a housing so as to be held by the housing, plating the terminal portions held by the housing, and subsequently separating the electrical connector from the carrier, as described in Japanese Patent No. 4287450 (Japanese Patent Laid-Open No. 2008-059884).

In the conventional electrical connector described in Japanese Patent No. 4287450 (Japanese Patent Laid-Open No. 2008-059884), since exposed surfaces of the terminals which are not in contact with the housing are plated, the terminals exhibit favorable electrical contact characteristics and solder-adhering characteristics. On the other hand, since contact surfaces of the terminals which are in contact with the housing are not plated, solder and flux are less likely to enter into the gap formed between the housing and the contact surfaces of the terminals.

The conventional electrical connector described above has a problem in that when, after fittings (such as terminals and reinforcement fittings) are integrally molded with the housing and held by the housing, the entire fittings are plated, manufacturing costs related to the plating and the like increase.

In particular, a recent problem needed to be solved is that when adopting an expensive plate with relatively high conductivity or an expensive plate with relatively high solder wettability as the plate to be used in plating, how to perform partial plating by weighting thickness (plating thickness) more or less according to degrees of importance of required conductivity, solder wettability, or the like with respect to each plated portion to be subjected to plating in a terminal of a fitting to be held by a housing in order to reduce manufacturing costs.

In consideration thereof, the present invention has been made in order to solve the problem in the prior art described above and the recent problem needed to be solved and an object of the present invention is to provide an electrical connector capable of reducing manufacturing costs by performing partial plating for each part of a terminal of a fitting to be integrally molded with and held by a housing by weighting plating thickness in accordance with an application of the part.

### SUMMARY OF THE INVENTION

In order to solve the problem described above, the present invention provides an electrical connector comprising: a housing including a lengthwise direction, a crosswise direction, and a height direction which are mutually orthogonal; and a fitting held by the housing, wherein the fitting is integrally molded with the housing by insert molding, the fitting is made of a conductive thin plate-shaped base material held by the housing, and the fitting includes a terminal of which surface is to be partially plated after the insert molding, the terminal includes: a mounting portion; a first wall; and a second wall; the mounting portion including a mounting surface which is to be mounted to a mounted object; the first wall being provided so as to extend in a first direction orthogonal to the mounting surface and forming a first wall surface including a single contact point configured to come into contact with a counterpart terminal; and the second wall being provided at an end on one side of the first wall in the first direction and forming an exposed surface being spaced apart from the mounting surface in the first direction and not coming into contact with the housing, the terminal being configured to come into contact with the counterpart terminal by the single contact point, and a first thickness of a plated portion on the first wall surface is greater than a second thickness of a plated portion on the exposed surface of the second wall.

In addition, the present invention provides an electrical connector to be mounted to an electrically-connected mounted object, the electrical connector including: a housing including a lengthwise direction, a crosswise direction, and a height direction which are mutually orthogonal; and a fitting held by the housing, wherein the fitting is integrally molded with the housing by insert molding, the fitting is made of a conductive thin plate-shaped base material held by the housing, and the fitting includes a terminal of which surface is to be partially plated after the insert molding, the terminal includes: a mounting portion including a mounting surface which is to be mounted to a mounted portion of the mounted object; a first wall which is provided so as to extend in a first direction orthogonal to the mounting surface and which forms a first wall surface including a single contact point capable of coming into contact with a counterpart terminal; and a second wall which is provided at an end on one side of the first wall in the first direction and which forms an exposed surface being spaced apart from the mounting surface in the first direction and not coming into contact with the housing, the terminal being configured to come into contact with the counterpart terminal by the single contact point, and the mounting surface of the mounting portion and the exposed surface of the second wall are to be plated after the insert molding, and a first thickness of a plated portion having been plated on the mounting surface is greater than a second thickness of a plated portion having been plated on the exposed surface.

With the electrical connector according to the present invention, manufacturing costs can be reduced by performing partial plating for each part of a terminal of a fitting to be integrally molded with and held by a housing by weighting plating thickness in accordance with an application of the part.

### BRIEF DESCRIPTION OF THE DRAWINGS

FIG. 1 is a perspective view of an electrical connector in a non-fitted state according to a first embodiment of the present invention;

FIG. 2 is a side view of the electrical connector in a non-fitted state according to the first embodiment of the present invention;

FIG. 3 is a sectional view taken along line III-III in FIG. 2;

FIG. 4A is a partially enlarged perspective view of a terminal portion of the receptacle connector of the electrical connector according to the first embodiment of the present invention as viewed from a counterpart connector side thereof (the plug connector side);

FIG. 4B is a partially enlarged perspective view of the terminal portion of the receptacle connector of the electrical connector according to the first embodiment of the present invention as viewed from a mounted portion side thereof;

FIG. 4C is a partially enlarged side view of the terminal portion of the receptacle connector of the electrical connector according to the first embodiment of the present invention as viewed from a lengthwise direction (longitudinal direction) of the receptacle connector;

FIG. 5A is a partially enlarged perspective view of a terminal portion of the plug connector of the electrical connector according to the first embodiment of the present invention as viewed from a counterpart connector side thereof (the receptacle connector side);

FIG. 5B is a partially enlarged perspective view of the terminal portion of the plug connector of the electrical connector according to the first embodiment of the present invention as viewed from a mounted portion side thereof;

FIG. 5C is a partially enlarged side view of the terminal portion of the plug connector of the electrical connector according to the first embodiment of the present invention as viewed from a lengthwise direction (longitudinal direction) of the plug connector; and

FIG. 6 is a sectional view of an electrical connector similar to FIG. 3 according to a second embodiment of the present invention.

### DETAILED DESCRIPTION OF THE PREFERRED EMBODIMENTS

Hereinafter, electrical connectors according to some embodiments of the present invention will be described with reference to the accompanying drawings.

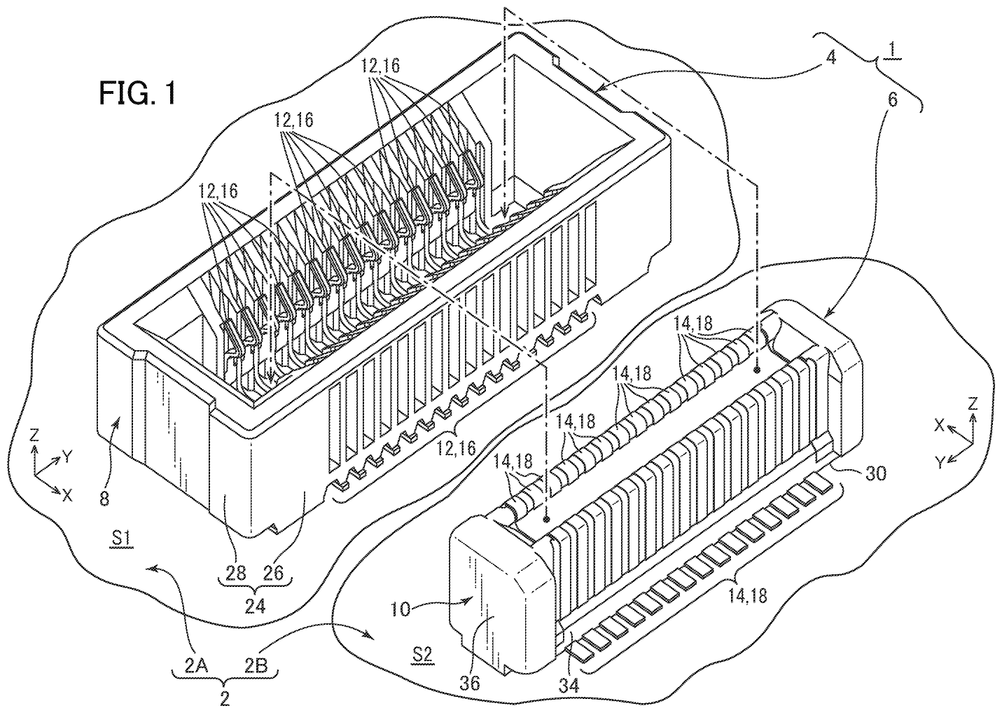

First, an electrical connector 1 according to a first embodiment of the present invention will be described with reference to FIGS. 1 to 10B.

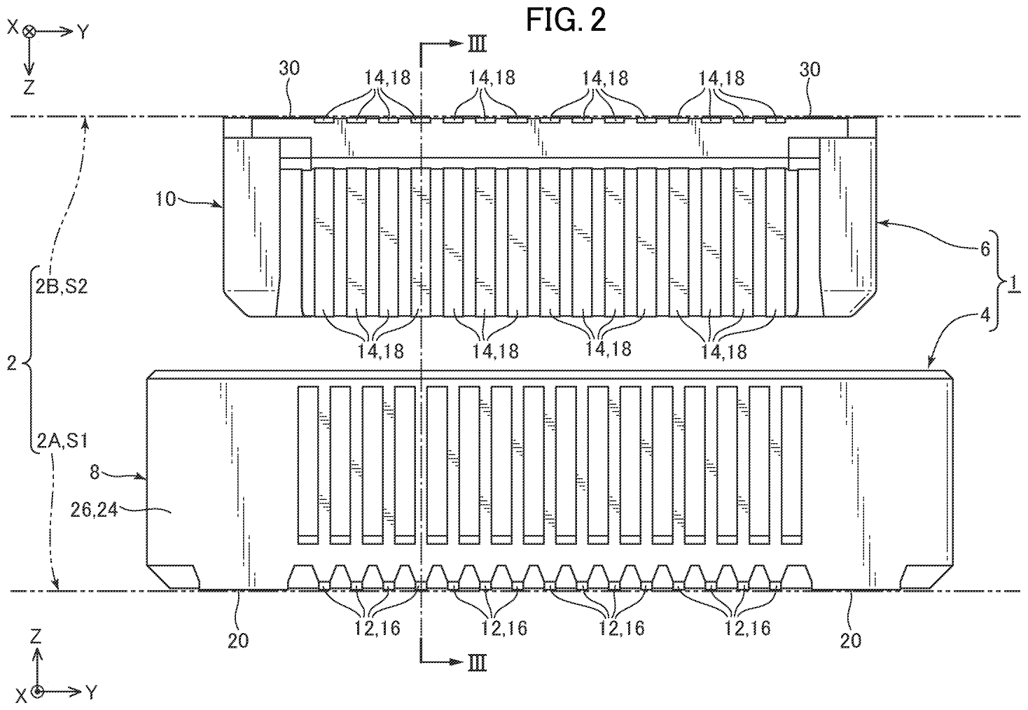

As shown in FIGS. 1 and 2, the electrical connector 1 according to the first embodiment of the present invention is to be mounted to a so-called electrically-connected mounted object 2 such as a circuit board of a mobile phone, a smartphone, a digital camera, a notebook personal computer, and other electronic equipment or an electrical connection part of a flexible flat cable.

The electrical connector 1 includes a pair of a receptacle connector 4 and a plug connector 6 which can be fitted to each other and released from each other.

Each of the connectors 4 and 6 is configured to be mounted to each of mounted surfaces S1 and S2 (first mounted surface S1 and second mounted surface S2) in each of different mounted portions 2A and 2B (first mounted portion 2A and second mounted portion 2B) of the mounted object 2 which corresponds to each of the connectors 4 and 6.

In the present specification and in the drawings, in the electrical connector 1, an X-axis direction (hereinafter, an “X direction”) among XYZ coordinate axes of a right-handed system constituted of three axes of an X axis, a Y axis, and a Z axis shown in FIG. 1 (as well as other drawings) which are mutually orthogonal is defined as a crosswise direction or a short-side direction of each of the connectors 4 and 6. The X direction corresponds to a normal direction of a YZ plane which is orthogonal to an XY plane constituting each of the mounted surfaces S1 and S2.

In addition, among the XYZ coordinate axes, a Y-axis direction (hereinafter, a “Y direction”) is defined as a lengthwise direction or a longitudinal direction of each of the connectors 4 and 6. The Y direction also corresponds to a normal direction of an XZ plane which is orthogonal to the XY plane constituting each of the mounted surfaces S1 and S2.

Furthermore, among the XYZ coordinate axes, a Z-axis direction (hereinafter, a “Z direction”) is defined as a height direction of each of the connectors 4 and 6 with respect to each of the mounted surfaces S1 and S2, or a fitting direction or a fitting release direction. The Z direction also corresponds to a normal direction which is orthogonal to the XY plane constituting each of the mounted surfaces S1 and S2.

In particular, a direction in which each of the connectors 4 and 6 approach each other in the Z direction (a direction of movement toward a proximal side) and a direction in which the connectors 4 and 6 fit each other (fitting direction) are assumed to be a “Z1 direction”. On the other hand, a direction in which each of the connectors 4 and 6 move away from each other in the Z direction (a direction of movement toward a distal side) and a direction in which the connectors 4 and 6 is released from each other (fitting release direction) are assumed to be a “Z2 direction”.

Next, as shown in FIGS. 1 to 3, the receptacle connector 4 and the plug connector 6 include, respectively, each of housings 8 and 10 (first housing 8 and second housing 10) which are made of resin and which have a substantially flat, rectangular shape, and fittings 12 and 14 (first fitting 12 and second fitting 14) which are held by each of the housings 8 and 10.

In addition, as shown in FIGS. 1 to 3, each of the fittings 12 and 14 of each of the connectors 4 and 6 is integrally molded with each of the housings 8 and 10 by insert molding, the fittings 12 and 14 are made of a conductive thin plate-shaped base material held by each of the housings 8 and 10, and each of the fittings 12 and 14 includes, respectively, terminals 16 and 18 (first terminal 16 (receptacle terminal 16) and second terminal 18 (plug terminal 18)).

Furthermore, after each of the fittings 12 and 14 is integrally molded with each of the housings 8 and 10 by insert molding, a surface of each of the terminals 16 and 18 is to be partially plated.

Details of the portion of each of the terminals 16 and 18 to be partially plated in each of the fittings 12 and 14 of the receptacle connector 4 and the plug connector 6 will be described later.

Next, details of each of the housings 8 and 10 of the receptacle connector 4 and the plug connector 6 will be described with reference to FIGS. 1 to 3.

As shown in FIGS. 1 to 3, each of the housings 8 and 10 respectively has a lengthwise direction (Y direction, longitudinal direction), a crosswise direction (X direction, short-side direction), and a height direction (Z direction) which are mutually orthogonal.

In addition, as shown in FIGS. 1 to 3, the first housing 8 of the receptacle connector 4 includes a bottom wall 20 which is arranged on the first mounted surface S1 of the first mounted portion 2A of the electrically-connected mounted object 2 which is a circuit board of an electronic equipment, an electrical connection part of a flexible flat cable, or the like.

Furthermore, the first housing 8 includes a protruding wall 22 which protrudes in a Z direction (fitting direction Z1) along a central axis C1 of the receptacle connector 4 which extends in the Z direction from a center part of the bottom wall 20 in the X direction.

In addition, the first housing 8 includes a peripheral wall 24 which is provided in an outer frame shape along an entire periphery of the first housing 8 on an outer side of an outer periphery of the protruding wall 22 in the X direction and the Y direction at an interval. The peripheral wall 24 includes a longitudinal wall 26 which extends in the Y direction (longitudinal direction) of the first housing 8 and a short-side wall 28 which extends in the X direction (short-side direction) of the first housing 8.

The longitudinal wall 26 and the short-side wall 28 of the peripheral wall 24 are also formed so as to protrude in the Z direction (fitting direction Z1) from the bottom wall 20.

In addition, each terminal 16 of the first fitting 12 are configured to be integrally assembled onto the first housing 8 by being integrally molded onto each of the walls 20, 22, 24, 26, and 28 of the first housing 8 by insert molding.

In a similar manner, as shown in FIGS. 1 to 3, the second housing 10 of the plug connector 6 includes a bottom wall 30 which is arranged on the second mounted surface S2 of the second mounted portion 2B of the electrically-connected mounted object 2 which is a circuit board of an electronic equipment, an electrical connection part of a flexible flat cable, or the like.

In addition, the second housing 10 includes a protruding wall 32 which protrudes in the Z direction (fitting direction Z1) along a central axis C2 of the plug connector 6 which extends in the Z direction from the bottom wall 30. The protruding wall 32 is also formed so as to extend in the Y direction (longitudinal direction) of the second housing 10.

Furthermore, the second housing 10 includes a longitudinal wall 34 which is provided on a base end side (a fitting release direction Z2 side) of the protruding wall 32 and on an outer side in the X direction (short-side direction) and which extends in the Y direction (longitudinal direction) of the second housing 10.

In addition, the second housing 10 includes a short-side wall 36 which is provided at an end of the protruding wall 32 and the longitudinal wall 34 in the Y direction (longitudinal direction) and which extends in the X direction (short-side direction) of the second housing 10.

In this case, each terminal 18 of the second fitting 14 is configured to be integrally assembled onto the second housing 10 by being integrally molded onto each of the walls 30, 32, 34, and 36 of the second housing 10 by insert molding.

Next, as shown in FIGS. 1 to 3, a first fitting depression 38 which can receive the protruding wall 32 and the second terminal 18 of the second housing 10 of the plug connector 6 when the plug connector 6 is fitted to the receptacle connector 4 is provided in an internal space area A1 on an inner side of the peripheral wall 24 in the X direction and the Y direction and in the fitting direction Z1 with respect to the protruding wall 22 in the first housing 8 of the receptacle connector 4.

In addition, as shown in FIGS. 1 to 3, a second fitting depression 40 which can receive the protruding wall 22 of the first housing 8 of the receptacle connector 4 when the plug connector 6 is fitted to the receptacle connector 4 is provided at an end of the protruding wall 32 in the fitting direction Z1 in the second housing 10 of the plug connector 6.

While the electrical connector 1 according to the present embodiment is described to have a form in which a length of the longitudinal wall 26 of the protruding wall 22 and the peripheral wall 24 of the first housing 8 in the Y direction (longitudinal direction) is longer than a length of the short-side wall 28 in the X direction (short-side direction) and a length of the longitudinal wall 34 of the second housing 10 in the Y direction (longitudinal direction) is longer than a length of the short-side wall 36 in the X direction (short-side direction), the electrical connector 1 is not limited to this form and the length of each of the longitudinal walls 26 and 34 in the Y direction (longitudinal direction) and the length of each of the short-side walls 28 and 36 in the X direction (short-side direction) may be the same.

Next, details of the portion of each of the terminals 16 and 18 to be partially plated in each of the fittings 12 and 14 of the receptacle connector 4 and the plug connector 6 of the electrical connector 1 according to the present embodiment will be described with reference to FIGS. 1 to 5C.

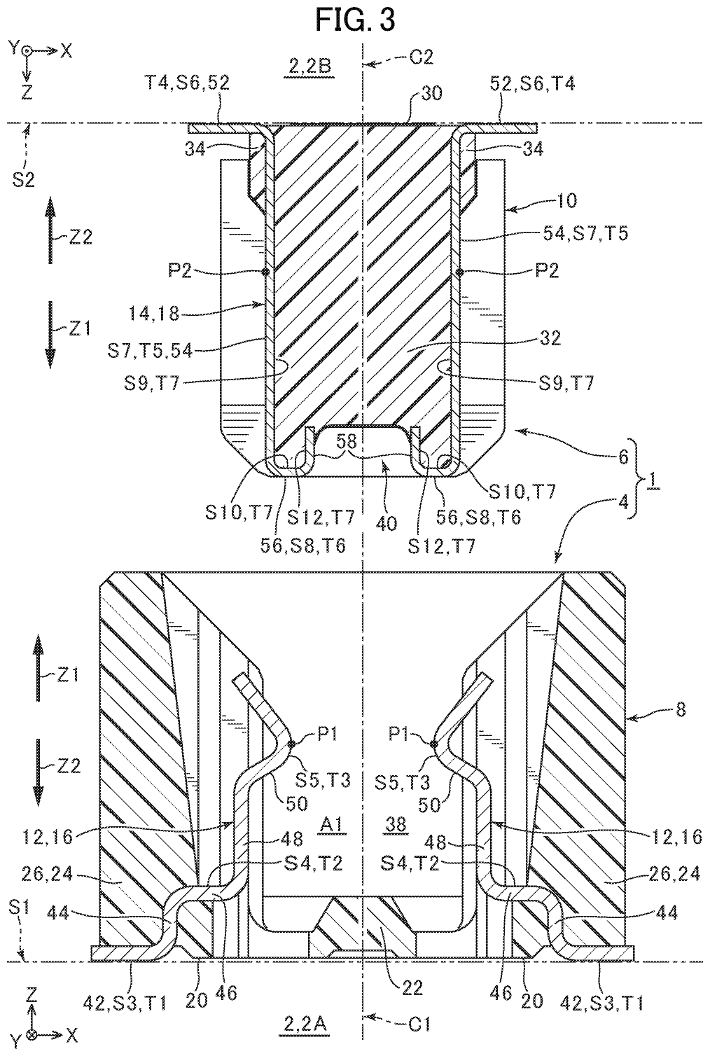

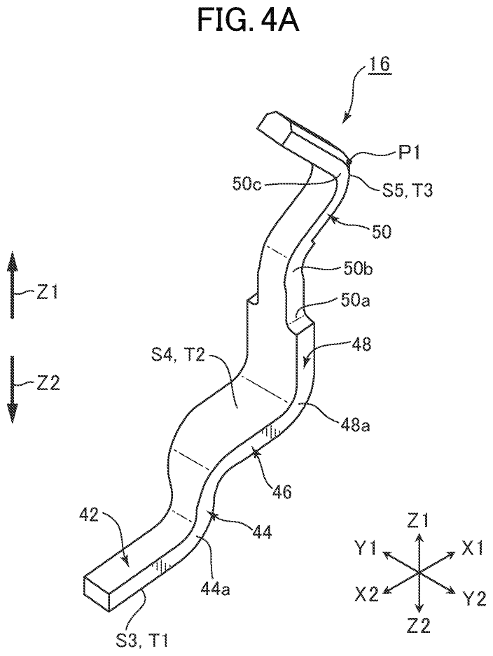

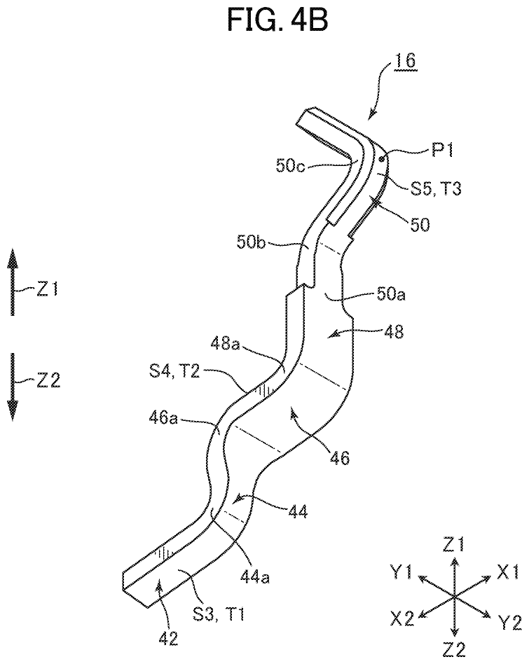

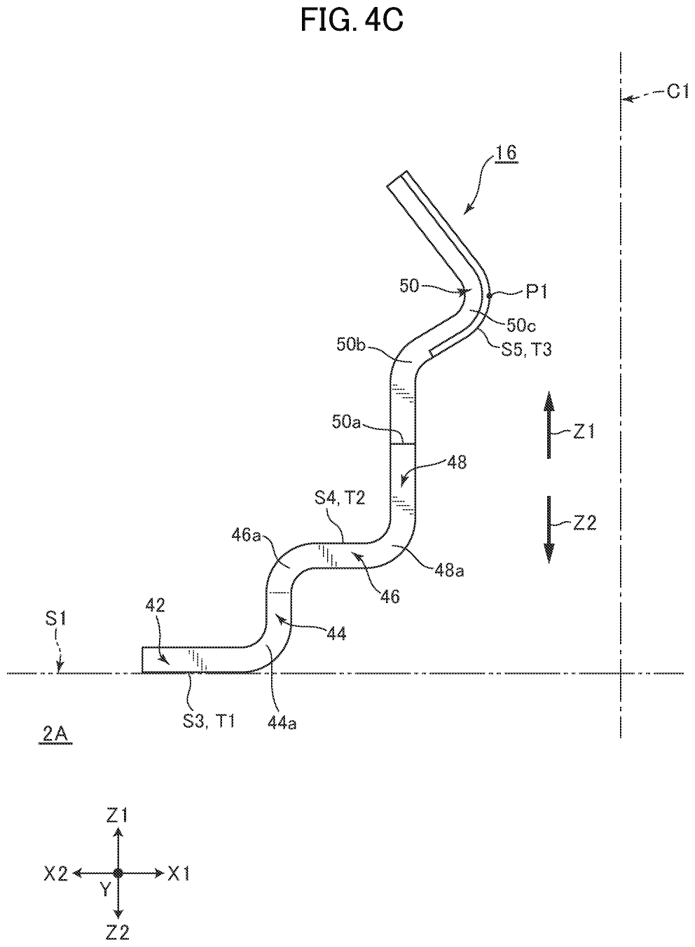

First, as shown in FIGS. 3 and 4A to 4C, the first terminal 16 of the receptacle connector 4 includes a first mounting wall 42 that is a first mounting portion to be mounted to the first mounted portion 2A of the mounted object 2.

In addition, the first terminal 16 generally includes four walls 44, 46, 48, and 50 (a first wall 44, a second wall 46, a third wall 48, and a fourth wall 50) from the first mounting wall 42 toward the central axis C1 of the receptacle connector 4.

A first mounting portion 42 of the first terminal 16 includes a first mounting surface S3 which is provided on one side of the thin plate-shaped base material in the thickness direction (Z direction) (in the Z2 direction of the first mounting portion 42 and on the first mounted portion 2A side shown in FIGS. 3 and 4A to 4C) and which opposes the first mounted surface S1 of the first mounted portion 2A.

Next, as shown in FIGS. 3 and 4A to 4C, the first wall 44 of the first terminal 16 bends in the Z1 direction from a connecting part 44a at one end of the first mounting wall 42 in the X1 direction and subsequently extends in the Z1 direction for a predetermined distance, and is held by the longitudinal wall 26 of the peripheral wall 24 of the first housing 8.

In addition, as shown in FIGS. 3 and 4A to 4C, the second wall 46 of the first terminal 16 bends in the X1 direction from a connecting part 46a at one end of the first wall 44 in the Z1 direction and subsequently extends in the X1 direction for a predetermined distance.

In this case, in the second wall 46, a part of a wall surface S4 thereof in the Z1 direction forms an exposed surface S4 which does not come into contact with the first housing 8.

Furthermore, as shown in FIGS. 3 and 4A to 4C, the third wall 48 of the first terminal 16 bends in the Z1 direction from a connecting part 48a at one end of the second wall 46 in the X1 direction and subsequently extends in the Z1 direction for a predetermined distance.

In addition, as shown in FIGS. 3 and 4A to 4C, the fourth wall 50 of the first terminal 16 extends from a connecting part 50a at one end of the third wall 48 in the Z1 direction to a bent part 50b in the Z1 direction. Subsequently, after extending from the bent part 50b to a curved part 50c in the X1 direction and the Z1 direction, the fourth wall 50 extends for a predetermined distance in the X2 direction and the Z1 direction from the curved part 50c.

In this case, in the fourth wall 50 of the first terminal 16, the curved part 50c forms a wall surface S5 including a single first contact point P1 which is capable of elastically coming into contact with a counterpart terminal (second terminal) 18 and also functions as an elastic contact piece.

In this case, the first mounting surface S3 of the first mounting wall 42, the exposed surface S4 of the second wall 46, and the wall surface S5 of the fourth wall 50 in the first terminal 16 are to be plated after the insert molding.

Furthermore, a thickness T1 of a plated portion which has been plated on the first mounting surface S3 is set to be greater than a thickness T2 of a plated portion which has been plated on the exposed surface S4 of the second wall 46 and smaller than a thickness T3 of a plated portion which has been plated on the wall surface S5 of the fourth wall 50 (T3>T1>T2).

Note that the thicknesses T1 and T3 are preferably set to 0.05 μm or more and the thickness T2 is preferably set to 0.03 μm or less.

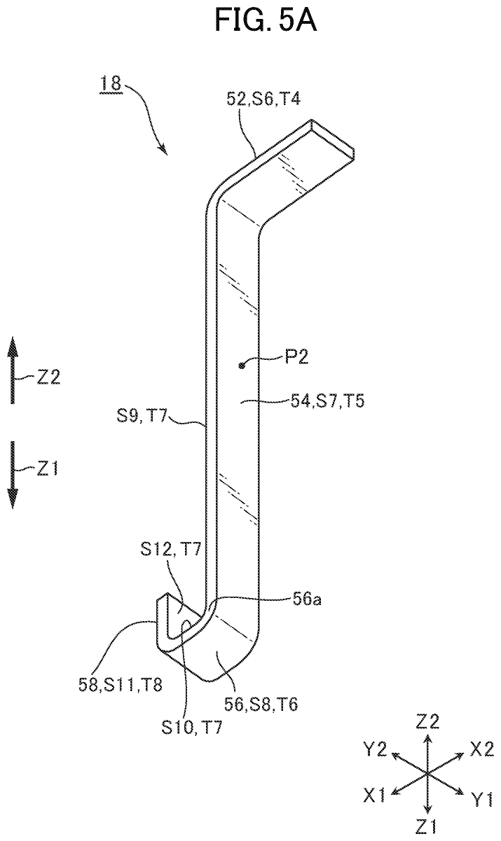

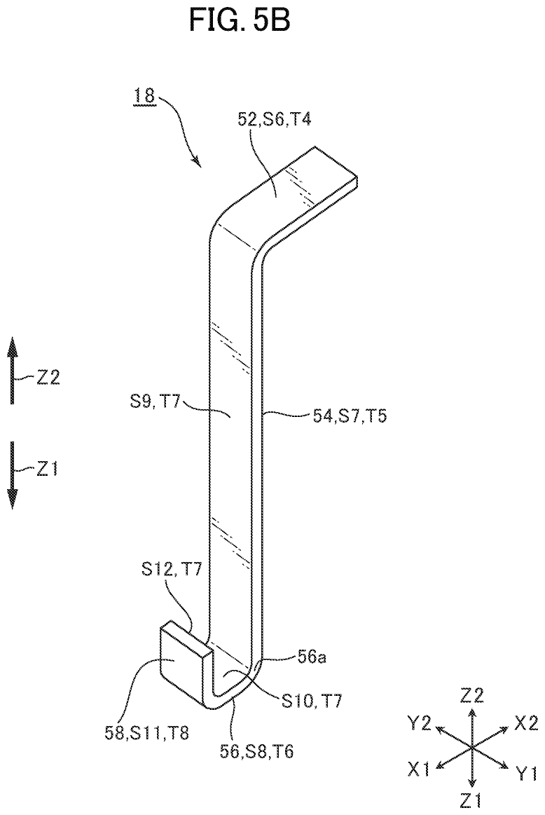

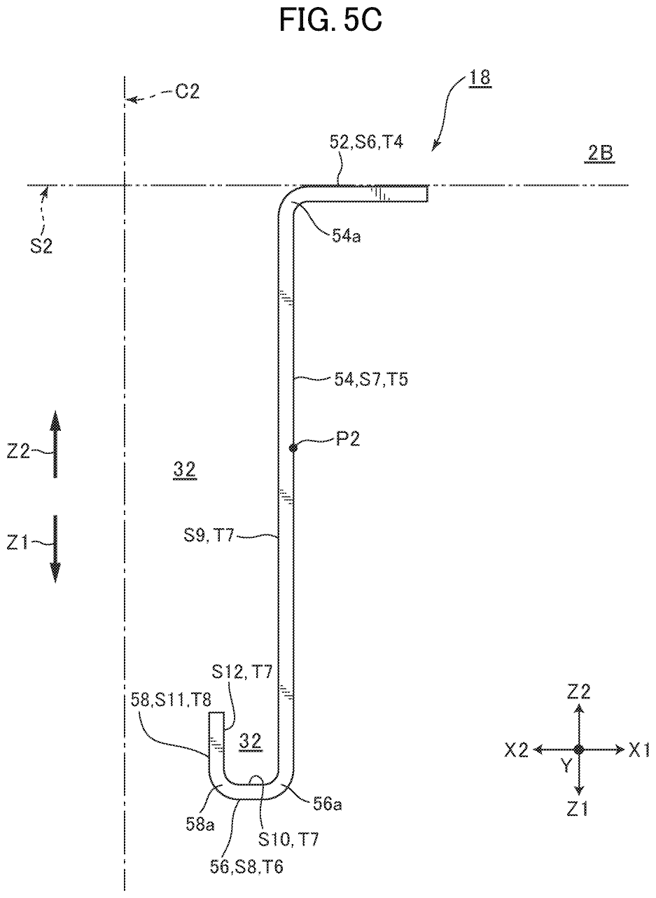

Next, as shown in FIGS. 3 and 5A to 5C, the second terminal 18 of the plug connector 6 includes a second mounting wall 52 that is a second mounting portion to be mounted to the second mounted portion 2B of the mounted object 2.

In addition, the second terminal 18 generally includes three walls 54, 56, and 58 (a first wall 54, a second wall 56, and a third wall 58) from the second mounting wall 52 toward the central axis C2 of the plug connector 6.

Furthermore, a second mounting portion 52 of the second terminal 18 includes a second mounting surface S6 which is provided on one side of the thin plate-shaped base material in the thickness direction (Z direction) (in the Z2 direction of the second mounting portion 52 and on the second mounted portion 2B side shown in FIGS. 3 and 5A to 5C) and which opposes the second mounted surface S2 of the second mounted portion 2B.

Next, as shown in FIGS. 3 and 5A to 5C, the first wall 54 of the second terminal 18 bends in the Z1 direction from a connecting part 54a at one end of the second mounting wall 52 in the X2 direction and subsequently extends in the Z1 direction for a predetermined distance.

In this case, the first wall 54 of the second terminal 18, forms a wall surface S7 which includes a single second contact point P2 that comes into contact with the single contact point P1 on the wall surface S5 of the fourth wall 50 of the counterpart terminal (first terminal) 16 when the receptacle connector 4 and the plug connector 6 are fitted to each other.

In addition, as shown in FIGS. 3 and 5A to 5C, the second wall 56 of the second terminal 18 bends in the X2 direction from a connecting part 56a at one end of the first wall 54 in the Z1 direction and subsequently extends in the X2 direction for a predetermined distance.

In this case, in the second wall 56 of the second terminal 18, a part of a wall surface S8 thereof in the Z1 direction forms an exposed surface S8 which does not come into contact with the second housing 10.

Furthermore, as shown in FIGS. 3 and 5A to 5C, the third wall 58 of the second terminal 18 bends in the Z2 direction from a connecting part 58a at one end of the second wall 56 in the X2 direction and subsequently extends in the Z2 direction for a predetermined distance.

In other words, as shown in FIGS. 3 and 5C, in the second terminal 18, a shape in which the first wall 54 bends in the Z2 direction from the connecting part 54a with the second mounting wall 52 and extends for a predetermined distance, the second wall 56 extends in the X2 direction from the connecting part 56a with the first wall 54, and the third wall 58 bends in the Z2 direction from the connecting part 58a with the second wall 56 generally assumes a shape (a so-called outer spiral shape) of being wound from outside to inside with respect to the central axis C2 of the plug connector 6.

In this case, the second mounting surface S6 of the second mounting wall 52, the wall surface S7 including the second contact point P2 of the first wall 54, and the exposed surface S8 of the second wall 56 in the second terminal 18 are to be plated after the insert molding.

Furthermore, a thickness T4 of a plated portion which has been plated on the second mounting surface S6 is set to be smaller than a thickness T5 of a plated portion which has been plated on the wall surface S7 of the first wall 54 and greater than a thickness T6 of a plated portion which has been plated on the exposed surface S8 of the second wall 56 (T5>T4>T6).

Note that the thicknesses T4 and T5 are preferably set to 0.05 μm or more and the thickness T6 is preferably set to 0.03 μm or less.

Next, as shown in FIGS. 3 and 5A to 5C, the first wall 54 of the second terminal 18 further includes a second wall surface S9 including a contact surface S9 which is provided on an opposite side (a side of the X1 direction) to the wall surface S7 (first wall surface S7) of the second terminal 18 in the second direction (X2 direction) that is orthogonal to the first direction (fitting direction Z1) and which comes into contact with a part of the protruding wall 32 of the second housing 10.

In addition, as shown in FIGS. 3 and 5A to 5C, the second wall 56 of the second terminal 18 further includes a second wall surface S10 including a contact surface S10 which is provided on an opposite side (the Z2 direction side) to the first wall surface (exposed surface) S8 of the second terminal 18 in the Z direction and which comes into contact with a part of the protruding wall 32 of the second housing 10.

Furthermore, as shown in FIGS. 3 and 5A to 5C, the third wall 58 of the second terminal 18 further includes a second wall surface S12 including a contact surface S12 which is provided on an opposite side (the X2 direction side) to the first wall surface S11 of the second terminal 18 in the X1 direction and which comes into contact with a part of the protruding wall 32 of the second housing 10.

Accordingly, a part of the protruding wall 32 of the second housing 10 is surrounded by the contact surface S9 of the first wall 54, the contact surface S10 of the second wall 56, and the contact surface S12 of the third wall 58 of the second terminal 18 and the second terminal 18 of the second fitting 14 is held by the second housing 10.

In this case, in the second wall surface S9 of the first wall 54, the second wall surface S10 of the second wall 56, and the second wall surface S12 of the third wall 58 of the second terminal 18 which come into contact with a part of the protruding wall 32 of the second housing 10, a thickness T7 of plated portions to be subjected to plating after the insert molding is set to 0 (T7=0).

Note that the first wall surface S11 of the third wall 58 of the second terminal 18 is to be plated after the insert molding. A thickness T8 of the plated portion to be subjected to plating on the first wall surface S11 of the third wall 58 of the second terminal 18 is set to be equal to or smaller than the thickness T7 of the wall surface S5 of the first wall 54 and greater than the thickness T6 of the exposed surface S8 of the second wall 56 (T7≥ T8>T6). Alternatively, the thickness T8 is set to be equal to or greater than the thickness T7 of the wall surface S5 of the first wall 54 and greater than the thickness T6 of the exposed surface S8 of the second wall 56 (T8≥T7>T6).

In addition, the thickness T8 is preferably set to 0.03 μm or less.

As a plate material to be used in the partial plating for each of the terminals 16 and 18 of the electrical connector 1 according to the present embodiment described above, a material with relatively high conductivity or solder wettability is particularly preferably adopted. Specifically, a precious metal such as gold (Au), silver (Ag), platinum (Pt), palladium (Pd) or the like is preferably adopted and, as a minimum, partial plating by so-called “gold plating” by adopting gold (Au) is preferably performed.

In addition, the gold to be adopted as a plate material is not limited to pure gold (100% Au) and may be a material containing Au as a principal component and small amounts of other metals.

Furthermore, the thicknesses T1 to T8 of the plated portions on the respective walls of each of the terminals 16 and 18 can be measured by X-ray florescence (XRF) analysis or scanning electron microscopy (SEM) which are well-known techniques.

In addition, while portions of each of the terminals 16 and 18 which come into close contact with resins of the housings 8 and 10 are made of bare metal (copper alloy), nickel (Ni) may be applied as base plating.

Furthermore, the method of performing partial plating for each of the fittings 12 and 14 which is held by each of the housings 8 and 10 after being integrally molded with each of the housings 8 and 10 by insert molding is a well-known technique as described in, for example, Japanese Patent Laid-Open No. 2013-213248.

In simple terms, a thin plate-shaped base material of each of the terminals 16 and 18 having been integrally molded with each of the housings 8 and 10 by insert molding is wound around an outer circumferential surface of a cylindrical support body drum which contains a plating solution. In addition, when the support body drum rotates, the thin plate-shaped base material of each of the terminals 16 and 18 is fed and, at the same time, the predetermined plating area of each of the terminals 16 and 18 are plated with the plating solution being jetted from plating holes on the outer circumferential surface of the support body drum opposing the predetermined plating area of each of the terminals 16 and 18.

Next, an advantageous effect of the electrical connector 1 according to the first embodiment of the present invention will be described with reference to FIGS. 1 to 5C.

With the electrical connector 1 according to the present embodiment described above, each of the fittings 12 and 14 is integrally molded with each of the housings 8 and by insert molding and, after each of the fittings 12 and 14 is integrally held by each of the housings 8 and 10, plating is partially performed on surfaces of the fittings 12 and 14.

Accordingly, manufacturing efficiency can be improved as compared to a case of adopting a step where, for example, after plating is performed in advance on the fittings, each of the plated fittings 12 and 14 is press-fitted into each of the housings 8 and 10 when the electrical connector 1 is being manufactured.

In addition, since plating is only partially performed on a part of a surface of each of the fittings 12 and 14 which require plating and there is no need to perform plating on the entire surface of each of the fittings 12 and 14, manufacturing costs related to plating or the like can be reduced.

In particular, even when an expensive plate with relatively high conductivity or an expensive plate with relatively high solder wettability is adopted as the plate to be used in plating, since a portion where the plating is to be performed is limited to a part of the surfaces of the fittings, manufacturing costs can be reduced effectively.

Furthermore, when plating is partially performed on the surface of each of the fittings 12 and 14, plating is performed on the wall surfaces S5 and S7 which include the single contact points P1 and P2 capable of coming into contact with the counterpart terminals 16 and 18 in the walls 50 and 54 of each of the terminals 16 and 18 and plating is also performed on the exposed surfaces S4 and S8 which do not come into contact with each of the housings 8 and 10 in the walls 46 and 56 of each of the terminals 16 and 18.

In this case, each of the thicknesses T3 and T5 of the plated portions which have been plated on the wall surfaces S5 and S7 of the walls 50 and 54 of the each of the terminals 16 and 18 including the single contact points P1 and P2 capable of coming into contact with the counterpart terminals 16 and 18 is set greater than each of the thicknesses T2 and T6 of the plated portions which have been plated on the exposed surfaces S4 and S8 of the walls 46 and 56 of each of the terminals 16 and 18 (T3>T2, T5>T6).

Accordingly, electrical resistance of the wall surfaces S5 and S7 of the walls 50 and 56 of each of the terminals 16 and 18 which include the single contact points P1 and P2 that come into contact with the counterpart terminals 16 and 18 can be reduced and conductivity can be improved.

On the other hand, the plating thicknesses (thicknesses T2 and T6) on the exposed surfaces S4 and S8 of the second walls 46 and 56 of each of the terminals 16 and 18 which do not come into contact with each of the housings 8 and 10 and which hardly contribute to conductivity to the counterpart terminals 16 and 18 as compared to the walls 50 and 54 of each of the terminals 16 and 18 can be reduced and manufacturing costs related to plating and the like can be reduced.

As a result, manufacturing costs can be reduced while improving electrical characteristics of the electrical connector 1 by performing partial plating for each of the terminals 16 and 18 of each of the fittings 12 and 14 to be integrally molded with and held by each of the housings 8 and 10 by weighting plating thickness in accordance with an application of the part.

In addition, with the electrical connector 1 according to the present embodiment, the thicknesses T1 and T4 of the plated portions having been plated on the mounting surfaces S3 and S6 of the mounting portions 42 and 52 of each of the terminals 16 and 18 are set smaller than the thicknesses T3 and T5 of the plated portions on the wall surfaces S5 and S7 of the walls 50 and 54 of each of the terminals 16 and 18 and greater than the thicknesses T2 and T6 of the plated portions on the exposed surfaces S4 and S8 of the walls 46 and 56 of each of the terminals 16 and 18 (T3>T1>T2 and T5>T4>T6).

Accordingly, solder wettability of the plated portions with the thicknesses T1 and T4 on the mounting surfaces S3 and S6 in the mounting portions 42 and 52 of each of the terminals 16 and 18 can be made favorable.

Therefore, the mounting portions 42 and 52 of the terminals 16 and 18 of each of the fittings 12 and 14 being held by the each of the housings 8 and 10 of the electrical connector 1 can be securely fixed to the mounted portions 2A and 2B of the mounted object 2 and the electrical connector 1 can be reliably mounted to the mounted object 2.

In addition, by making the thicknesses T3 and T5 of the plated portions on the wall surfaces S5 and S7 in the walls 50 and 54 of each of the terminals 16 and 18 greater than the thicknesses T1 and T4 of the plated portions having been plated on the mounting surfaces S3 and S6 of the mounting portions 42 and 52 of each of the terminals 16 and 18, electrical resistance of the wall surfaces S5 and S7 of the walls 50 and 54 of each of the terminals 16 and 18 can be reduced and conductivity can be improved.

Furthermore, by making the plating thicknesses (thicknesses T2 and T6) on the exposed surfaces S4 and S8 in the walls 46 and 56 of each of the terminals 16 and 18 smaller than the thicknesses T1 and T4 of the plated portions having been plated on the mounting surfaces S3 and S6 of the mounting portions 42 and 52 of each of the terminals 16 and 18, the plating thicknesses (thicknesses T2 and T6) on the exposed surfaces S4 and S8 in the walls 46 and 56 of each of the terminals 16 and 18 can be reduced and manufacturing costs related to plating and the like can be reduced.

Furthermore, with the electrical connector 1 according to the present embodiment, since consideration need not be given to conductivity and solder wettability with respect to the wall surfaces S9, S10, and S12 of the walls 54, 56, and 58 of the second terminal 18 which only function as contact surfaces that come into contact with a part of the protruding wall 32 of the second housing 10 of the plug connector 6, the thickness T7 of the plated portion to be subjected to plating is set to 0 (T7=0).

Accordingly, plating can be omitted and manufacturing costs can be reduced.

Next, with the electrical connector 1 according to the present embodiment, partial plating by so-called “gold plating” in which gold (Au) is adopted is performed as a minimum for each of the plurality of terminals 16 and 18 of each of the fittings 12 and 14.

With such gold plating, conductivity and durability in each of the terminals 16 and 18 of each of the fittings 12 and 14 can be maintained.

In addition, limiting plating that adopts relatively expensive gold plating to partial locations can reduce manufacturing costs.

In addition, with the electrical connector 1 according to the present embodiment, partial plating is performed for each of the plurality of terminals 16 of the fitting 12 of the receptacle connector 4.

Accordingly, in the receptacle connector 4, manufacturing costs can be reduced while maintaining conductivity and durability in each of the terminals 16 of the fitting 12.

In addition, with the electrical connector 1 according to the present embodiment, partial plating is performed for each of the plurality of terminals 18 of the fitting 14 of the plug connector 6.

Accordingly, in the plug connector 6, manufacturing costs can be reduced while maintaining conductivity and durability in each of the terminals 18 of the fitting 14.

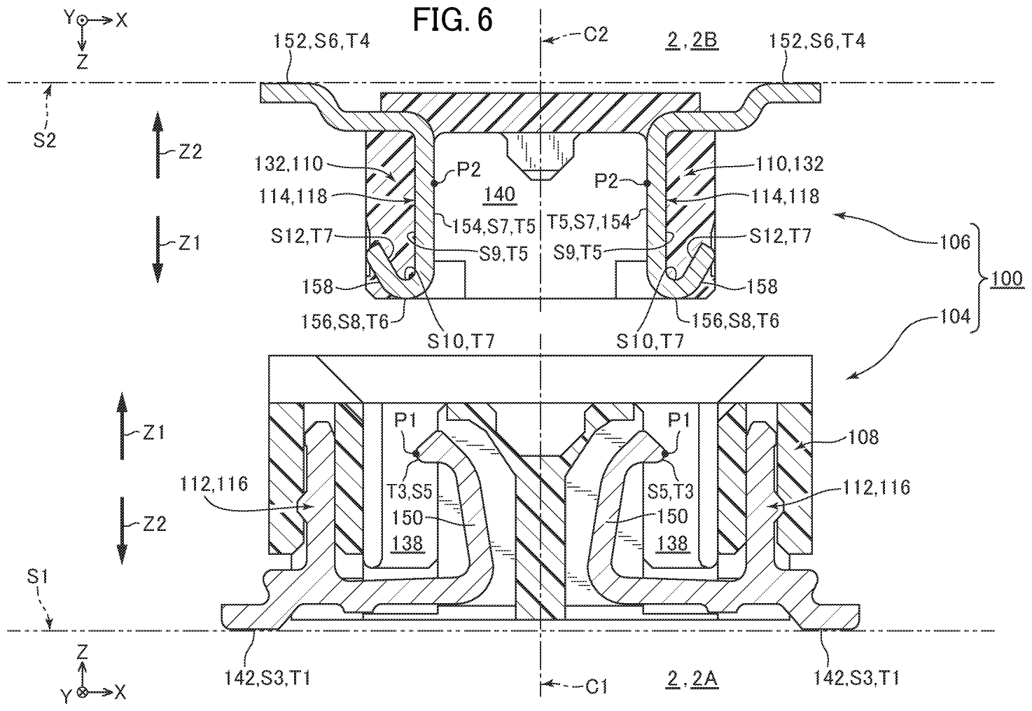

Next, an electrical connector 100 according to a second embodiment of the present invention will be described with reference to FIG. 6.

In the electrical connector 100 according to the present embodiment shown in FIG. 6, same portions as the electrical connector 1 according to the first embodiment of the present invention described above will be denoted by same reference signs and descriptions thereof will be omitted.

First, as shown in FIG. 6, in the electrical connector 100 according to the present embodiment, a first terminal 116 of a first fitting 112 of a receptacle connector 104 is press-fitted into a first housing 108, which differs from the first terminal 16 of the first fitting 12 of the receptacle connector 4 of the electrical connector 1 according to the first embodiment of the present invention described above being integrally molded with the first housing 8 by insert molding.

In addition, in the electrical connector 100 according to the embodiment, a second terminal 118 of a second fitting 114 of a plug connector 106 has a shape (a so-called inner spiral shape) of being wound from inside to outside with respect to the central axis C2 of the plug connector 106 which differs from the shape (a so-called outer spiral shape) of being wound from outside to inside with respect to the central axis C2 of the plug connector 6 in the second terminal 18 of the plug connector 6 of the electrical connector 1 according to the first embodiment of the present invention described above.

Furthermore, when the receptacle connector 104 and the plug connector 106 are fitted to each other in the fitting direction Z1, the second terminal 118 is to fit inside the first fitting depression 138 of the first housing 108 of the receptacle connector 104 and, at the same time, an elastic contact piece 150 of the first terminal 116 is to fit inside the second fitting depression 140 of the second housing 110 of the plug connector 106.

Moreover, the single first contact point P1 of the elastic contact piece 150 of the first terminal 116 is to come into contact with the second contact point P2 of the second terminal 118, and the first terminal 116 and the second terminal 118 are to come into contact with each other by single contact points P1, P2.

As shown in FIG. 6, with the electrical connector 100 according to the present embodiment, the second fitting 114 of the plug connector 106 is integrally molded with the second housing 110 by insert molding and, after the second fitting 114 is integrally held by the second housing 110, plating is partially performed on a surface of the fitting 114.

Accordingly, manufacturing efficiency can be improved as compared to a case of adopting a step where, for example, after plating is performed in advance on the fittings, the second fitting 114 plated is press-fitted into the second housing 110 when the electrical connector 100 is being manufactured.

In addition, since plating is partially performed on a part of a surface of each of the fittings 112 and 114 which require plating and there is no need to perform plating on the entire surface of each of the fittings 112 and 114, manufacturing costs related to plating or the like can be reduced.

In particular, even when an expensive plate with relatively high conductivity or an expensive plate with relatively high solder wettability is adopted as the plate to be used in plating, since a portion where the plating is to be performed is limited to a part of the surface of each of the fittings 112 and 114, manufacturing costs can be reduced effectively.

Furthermore, when plating is partially performed on the surface of each of the fittings 112 and 114, plating is performed on the wall surfaces S5 and S7 which include the single contact points P1 and P2 capable of coming into contact with the counterpart terminals 116 and 118 in the walls 150 and 154 of each of the terminals 116 and 118 and plating is also performed on the exposed surface S8 which does not come into contact with the second housing 110 in the wall 156 of the second terminal 118.

In this case, each of the thicknesses T3 and T5 of the plated portions which have been plated on the wall surfaces S5 and S7 of the walls 250 and 254 of the each of the terminals 116 and 118 including the single contact points P1 and P2 capable of coming into contact with the counterpart terminals 116 and 118 is set greater than the thickness T6 of the plated portion which has been plated on the exposed surface S8 of the wall 156 of the second terminal 118 (T3>T6, T5>T6).

Accordingly, electrical resistance of the wall surface S7 of the wall 156 of the second terminal 118 which includes the single contact point P2 that comes into contact with the counterpart terminal 116 can be reduced and conductivity can be improved.

On the other hand, the plating thickness (thickness T6) on the exposed surface S8 of the wall 156 of the second terminal 118 which does not come into contact with the second housing 110 and which hardly contributes to conductivity to the counterpart terminal 116 as compared to the wall 154 of the second terminal 118 can be reduced and manufacturing costs related to plating and the like can be reduced.

As a result, manufacturing costs can be reduced while improving electrical characteristics of the electrical connector 100 by performing partial plating for at least each part of the second terminal 118 of the second fitting 114 to be integrally molded with and held by the second housing 110 by weighting plating thickness in accordance with an application of the part.

In addition, with the electrical connector 100 according to the present embodiment, the thicknesses T1 and T4 of the plated portions having been plated on the mounting surfaces S3 and S6 of the mounting portions 142 and 152 of each of the terminals 116 and 118 are set smaller than the thicknesses T3 and T5 of the plated portions on the wall surfaces S5 and S7 of the walls 150 and 154 of each of the terminals 116 and 118 and greater than the thickness T6 of the plated portion on the exposed surface S8 of the wall 156 of the second terminal 118 (T3>T1>T6 and T5>T4>T6).

Accordingly, solder wettability of the plated portions with the thicknesses T1 and T4 on the mounting surfaces S3 and S6 in the mounting portions 142 and 152 of each of the terminals 116 and 118 can be made favorable.

Therefore, the mounting portions 142 and 152 of the terminals 116 and 118 of each of the fittings 112 and 114 held by the each of the housings 108 and 110 of the electrical connector 100 can be securely fixed to the mounted portions 2A and 2B of the mounted object 2 and the electrical connector 100 can be reliably mounted to the mounted object 2.

In addition, by making the thicknesses T3 and T5 of the plated portions on the wall surfaces S5 and S7 in the walls 150 and 154 of each of the terminals 116 and 118 greater than the thicknesses T1 and T4 of the plated portions having been plated on the mounting surfaces S3 and S6 of the mounting portions 142 and 152 of each of the terminals 116 and 118, electrical resistance of the wall surfaces S5 and S7 of the walls 150 and 154 of each of the terminals 116 and 118 can be reduced and conductivity can be improved.

Furthermore, by making the plating thickness (thickness T6) on the exposed surface S8 in the wall 156 of the second terminal 118 smaller than the thicknesses T1 and T4 of the plated portions having been plated on the mounting surfaces S3 and S6 of the mounting portions 142 and 152 of each of the terminals 116 and 118, at least the plating thickness (thickness T6) on the exposed surface S8 in the wall 156 of the second terminal 118 can be reduced and manufacturing costs related to plating and the like can be reduced.

Furthermore, with the electrical connector 100 according to the present embodiment, since consideration need not be given to conductivity and solder wettability with respect to the wall surfaces S9, S10, and S12 of the walls 154, 156, and 158 of the second terminal 118 which only function as contact surfaces that come into contact with a part of the protruding wall 132 of the second housing 110 of the plug connector 106, the thickness T7 of the plated portion to be subjected to plating is set to 0 (T7=0).

Accordingly, plating can be omitted and manufacturing costs can be reduced.

Next, with the electrical connector 100 according to the present embodiment, partial plating by so-called “gold plating” in which gold (Au) is adopted is performed as a minimum for each of the plurality of terminals 116 and 118 of each of the fittings 112 and 114.

With such gold plating, conductivity and durability in each of the terminals 116 and 118 of each of the fittings 112 and 114 can be maintained.

In addition, limiting plating that adopts relatively expensive gold plating to partial locations can reduce manufacturing costs.

In addition, with the electrical connector 100 according to the present embodiment, partial plating is performed for each of the plurality of terminals 116 of the fitting 112 of the receptacle connector 104.

Accordingly, in the receptacle connector 104, manufacturing costs can be reduced while maintaining conductivity and durability in each of the terminals 116 of the fitting 112.

Furthermore, with the electrical connector 100 according to the present embodiment, partial plating is performed for each of the plurality of terminals 118 of the fitting 114 of the plug connector 106.

Accordingly, in the plug connector 106, manufacturing costs can be reduced while maintaining conductivity and durability in each of the terminals 118 of the fitting 114.

What is claimed is:

1. An electrical connector comprising:
a housing including a lengthwise direction, a crosswise direction, and a height direction which are mutually orthogonal; and
a fitting held by the housing,
wherein the fitting is integrally molded with the housing by insert molding, the fitting is made of a conductive thin plate-shaped base material held by the housing, and the fitting includes a terminal of which surface is to be partially plated after the insert molding,
the terminal includes: a mounting portion; a first wall; and a second wall; the mounting portion including a mounting surface which is to be mounted to a mounted object; the first wall being provided so as to extend in a first direction orthogonal to the mounting surface and forming a first wall surface including a single contact point configured to come into contact with a counterpart terminal; and the second wall being provided at an end on one side of the first wall in the first direction and forming an exposed surface being spaced apart from the mounting surface in the first direction and not coming into contact with the housing, the terminal being configured to come into contact with the counterpart terminal by the single contact point, and
a first thickness of a plated portion on the first wall surface is greater than a second thickness of a plated portion on the exposed surface of the second wall.

2. The electrical connector according to claim 1, wherein a third thickness of a plated portion on the mounting surface is smaller than the first thickness and greater than the second thickness.

3. An electrical connector comprising:
a housing including a lengthwise direction, a crosswise direction, and a height direction which are mutually orthogonal; and
a fitting held by the housing;
wherein the fitting is integrally molded with the housing by insert molding, the fitting is made of a conductive thin plate-shaped base material held by the housing, and the fitting includes a terminal of which surface is to be partially plated after the insert molding,
the terminal includes: a mounting portion; a first wall; and a second wall; the first wall including a mounting surface which is to be mounted to a mounted object, the first wall being provided so as to extend in a first direction orthogonal to the mounting surface and forming a first wall surface including a single contact point configured to come into contact with a counterpart terminal, and the second wall being provided at an end on one side of the first wall in the first direction and forming an exposed surface being spaced apart from the mounting surface in the first direction and not coming into contact with the housing, the terminal being configured to come into contact with the counterpart terminal by the single contact point, and
a first thickness of a plated portion on the mounting surface is greater than a second thickness of a plated portion on the exposed surface.

4. The electrical connector according to claim 3, wherein a third thickness of a plated portion on the first wall surface is greater than the first thickness.

5. The electrical connector according to claim 1, wherein the first wall further includes a second wall surface which is provided on an opposite side to the first wall surface in a second direction orthogonal to the first direction and which includes a contact surface that comes into contact with a part of the housing, and a thickness of a plated portion on the second wall surface after the insert molding is 0.

6. The electrical connector according to claim 3, wherein the first wall further includes a second wall surface which is provided on an opposite side to the first wall surface in a second direction orthogonal to the first direction and which includes a contact surface that comes into contact with a part of the housing, and a thickness of a plated portion on the second wall surface after the insert molding is 0.

7. The electrical connector according to claim 1, wherein the plating is performed by gold plating.

8. The electrical connector according to claim 3, wherein the plating is performed by gold plating.

9. The electrical connector according to claim 1, wherein the electrical connector comprises a receptacle connector, the receptacle connector includes the housing and the fitting held by the housing,
the housing includes: a bottom wall; a protruding wall; and a fitting depression; the bottom wall being arranged on a mounted portion of the mounted object, the protruding wall protruding in a height direction of the housing from the bottom wall, the peripheral wall including a longitudinal wall and a short-side wall which are provided at an interval on an outer periphery of the protruding wall, and the fitting depression being provided on an inner side of the peripheral wall, and
the terminal of the fitting is a receptacle terminal, the receptacle terminal includes: the mounting portion; the first wall; the second wall; and a third wall; the third wall bending in a height direction of the housing from the mounting portion and extending, the second wall bending in the crosswise direction of the housing from a connecting part with the third wall, and the first wall extending in the first height direction from a connecting part with the second wall and being configured to elastically come into contact with a counterpart-side terminal, and the third wall is held by the longitudinal wall of the peripheral wall of the housing.

10. The electrical connector according to claim 3, wherein the electrical connector comprises a receptacle connector, the receptacle connector includes the housing and the fitting held by the housing,
the housing includes: a bottom wall; a protruding wall; and a fitting depression; the bottom wall being arranged on a mounted portion of the mounted object, the protruding wall protruding in a height direction of the housing from the bottom wall, the peripheral wall including a longitudinal wall and a short-side wall which are provided at an interval on an outer periphery of the protruding wall, and the fitting depression being provided on an inner side of the peripheral wall, and
the terminal of the fitting is a receptacle terminal, the receptacle terminal includes the mounting portion; the first wall; the second wall; and a third wall; the third wall bending in a height direction of the housing from the mounting portion and extending, the second wall bending in the crosswise direction of the housing from a connecting part with the third wall, and the first wall extending in the first height direction from a connecting part with the second wall and being configured to elastically come into contact with a counterpart-side terminal, and the third wall is held by the longitudinal wall of the peripheral wall of the housing.

11. The electrical connector according to claim 1, wherein the electrical connector comprises a plug connector, the plug connector includes the housing and the fitting held by the housing,
the housing includes: a bottom wall; and a protruding wall; the bottom wall being arranged on a mounted portion of the mounted object and the protruding wall protruding in a height direction of the housing from the bottom wall, and
the terminal of the fitting is a plug terminal, the plug terminal includes the mounting portion; a first wall; a second wall; and a third wall; the first wall bending in a first height direction of the housing from the mounting portion and extending, the second wall bending in the crosswise direction of the housing from a connecting part with the first wall and extending, and the third wall extending in a second height direction on an opposite side to the first height direction from a connecting part with the second wall, and the fitting is held by the housing since a part of the protruding wall of the housing is surrounded by the first wall, the second wall, and the third wall of the plug terminal.

12. The electrical connector according to claim 3, wherein the electrical connector comprises a plug connector, the plug connector includes the housing and the fitting held by the housing,
the housing includes: a bottom wall; and a protruding wall; the bottom wall being arranged on a mounted portion of the mounted object and a protruding wall protruding in a height direction of the housing from the bottom wall, and
the terminal of the fitting is a plug terminal, the plug terminal includes the mounting portion; a first wall; a second wall; and a third wall; the first wall bending in a first height direction of the housing from the mounting portion and extending, the second wall bending in the crosswise direction of the housing from a connecting part with the first wall and extending, and the third wall extending in a second height direction on an opposite side to the first height direction from a connecting part with the second wall, and the fitting is held by the housing since a part of the protruding wall of the housing is surrounded by the first wall, the second wall, and the third wall of the plug terminal.
